(19) United States
(12) Patent Application Publication
(10) Pub. No.: US 2008/0008449 A1
(43) Pub. Date: Jan. 10, 2008

(54) Data recording method and data recording device

(75) Inventors: Hajime Aoyama, Ome-shi (JP); Seigo Ito, Hanno-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/819,874

(22) Filed: Jun. 29, 2007

(30) Foreign Application Priority Data
Jun. 30, 2006 (JP) 2006-182336

(51) Int. Cl. H04N 7/00

(52) U.S. Cl. 386/95

(57) ABSTRACT

According to one embodiment, a data recording method for recording a plurality of pieces of data simultaneously in a recordable region of a recording medium, comprising recording a plurality of pieces of recording data by a plurality of recording devices, and allocating a recordable region so that a recording start position of each of a plurality of recording devices is different from one another when a plurality of pieces of recording data is recorded by a plurality of recording devices.

### CROSS-REFERENCE TO RELATED APPLICATIONS

This application is based upon and claims the benefit of priority from Japanese Patent Application No. 2006-182336, filed Jun. 30, 2006, the entire contents of which are incorporated herein by reference.

### BACKGROUND

1. Field

One embodiment of the present invention relates to data recording methods and data recording devices.

2. Description of the Related Art

For example, there is known a data recording device capable of recording a plurality of pieces of data simultaneously, such as a video recording device including two-program simultaneous recording function. For example, Jpn. Pat. Appln. Publication No. 2001-216730 discloses a digital recording and reproducing device that simultaneously records and reproduces a plurality of channels on and from a randomly accessible recording medium. Here, digital data transferred simultaneously through a data channel of two systems is written in or read out from a first region of the recording medium alternately in a time division manner.

### BRIEF DESCRIPTION OF THE SEVERAL VIEWS OF THE DRAWINGS

A general architecture that implements the various features of the invention will now be described with reference to the drawings. The drawings and the associated description are provided to illustrate embodiments of the invention and not to limit the scope of the invention.

FIG. 1 is a view showing a block configuration of an entire recording and reproducing device (video recording device) to which an embodiment of the present invention is applied;

FIG. 2A is a view showing a state of an extent in an HDD as a recording medium;

FIG. 2B is a view showing a configuration of an extent management table;

FIG. 3 is a view showing a configuration of a case in which a plurality of pieces of data are recorded simultaneously;

FIG. 4A is a view showing a state in which recording is carried out in accordance with a method in prior art;

FIG. 4B is a view showing a state in which an unrecorded extent is created by deleting data recorded by an encoder 2;

FIG. 5 is a view for explaining an outline of a data recording method according to the present invention;

FIG. 6A is a view showing a state in which recording is carried out in accordance with the present embodiment;

FIG. 6B is a view showing a state in which an unrecorded extent is created by deleting data recorded by the encoder 2;

FIG. 7 is a flowchart for explaining a first embodiment of the data recording method;

FIG. 8 is a view showing an example of extent allocation at the time of recording a plurality of pieces of data;

FIG. 9 is a flowchart for explaining a second embodiment of the data recording method;

FIG. 10 is a view showing an example of extent allocation in a case of recording three pieces of data simultaneously;

FIG. 11 is a view for explaining a third embodiment of the data recording method;

FIG. 12A is a view showing a state in which an extent subsequent to an extent currently under recording is selected to be recorded in accordance with the order of address;

FIG. 12B is a view showing a state where the order of recording is selected depending on a distance from a periphery of a recording start position; and

FIG. 13 is a view for explaining another method for allocating an extent for recording.

### DETAILED DESCRIPTION

Various embodiments according to the invention will be described hereinafter with reference to the accompanying drawings. In general, according to one embodiment of the invention, there is provided a data recording method for recording a plurality of pieces of data simultaneously in a recordable region of a recording medium, comprising: recording a plurality of pieces of recording data by each of a plurality of recording devices; and allocating a recordable region so that each recording start position of the plurality of recording devices is different from one another when a plurality of pieces of recording data are recorded by the plurality of recording devices.

Hereinafter, embodiments of the present invention will be described with reference to the accompanying drawings.

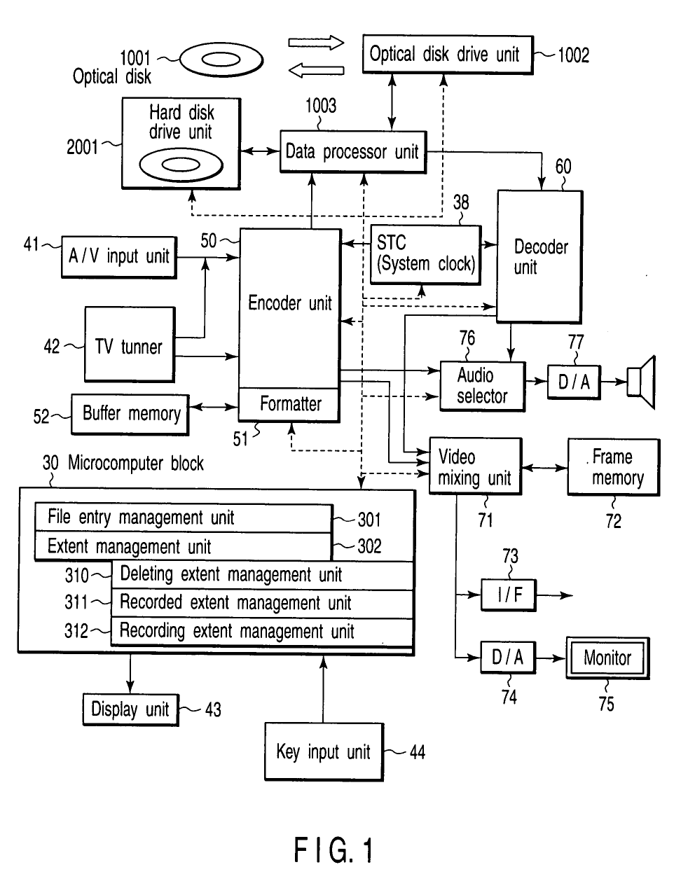

FIG. 1 shows a block configuration of an entire recording and reproducing device (video recording device) to which an embodiment of the present invention is applied. Although this embodiment shows a device (DVD-VR recorder with HDD) capable of handling both an optical disk such as a DVD-R and a hard disk as a recording medium, a semiconductor memory may be used in combination therewith as a recording medium. In FIG. 1, when each block is roughly classified, a left side shows main blocks in a recording unit and a right side shows main blocks in a reproducing unit.

The video recording device in FIG. 1 has two kinds of disk drive units. First, the video recording device has an optical disk drive unit 1002 that executes reading and writing of information by rotationally driving an optical disk (DVD-RAM, DVD±RW, DVD±R, and so on) 1001 as a first medium which is an information recording medium capable of building a video file. In addition, the video recording device has a hard disk drive unit 2001 (not shown) that drives a hard disk (HDD) as a second medium. A data processor unit 1003 can supply recording data to the optical disk drive unit 1002 and the hard disk drive unit 2001, and also receive a reproduced signal from these units. The optical disk drive unit 1002 has a rotational control system of the optical disk 1001, a laser drive system (using red laser with a wavelength of 650 nm, or blue laser with a wavelength of 405 nm or less), an optical system, and so on. The data processor unit 1003 is for handling data in a unit of recording or reproducing, and includes a buffer circuit, modulation and demodulation circuit, an error correction unit, and so on.

In addition, the video recording device in FIG. 1 includes, as main configuration elements, an encoder unit 50 that configures a recording side, a decoder unit 60 that configures a reproducing side, and a microcomputer block (may be referred to as a system control unit) 30 that controls operation of a device main body. The encoder unit 50 is configured with a plurality of encoders. Each of the encoders has an analog and digital converter for video use and audio use which digitalizes an input analog video signal and an input analog audio signal, a video encoder, and an audio encoder. Further, each of the encoders includes a sub-video encoder. An output of the encoder unit 50 is converted to a predetermined format of DVD-RAM in a formatter 51 including buffer memory, and is supplied to the data processor unit 1003 described above. To the encoder unit 50, an external analog video signal and an external analog audio signal are input from an A/V input unit 41, or an analog video signal and an analog audio signal from a TV tuner unit 42.

When a digital video signal and a digital audio signal in a compressed state are directly input, the encoder unit 50 can also supply the compressed digital video signal and digital audio signal directly to the formatter 51. In addition, the encoder unit 50 can also directly supply a digital video signal and audio signal analog-digital converted to a video mixing unit 71 and an audio selector 76. In the video encoder included in the encoder unit 50, a digital video signal is converted to a digital video signal compressed with a variable bit rate based on an MPEG 2 (or MPEG 1 or MPEG 4-AVC) standard. A digital audio signal is converted to a digital audio signal compressed with a constant bit rate based on an MPEG or an AC-3 standard, or a digital audio signal of linear PCM.

When a sub-video signal is input from the A/V input unit 41 (for example, a signal from a DVD video player with an independent output terminal for a sub-video signal), or when a DVD video signal of a data configuration such as above is broadcast and is received by the TV tuner unit 42, a sub-video signal in the DVD video signal is encoded (run-length encoded) in the sub-video encoder and becomes a sub-video bitmap. The encoded digital video signal, digital audio signal, and sub-video signal are packed in the formatter 51, and become a video pack, an audio pack, and a sub-video pack. Further, these packs are assembled, and converted to a format specified by a DVD-video standard (DVD video format) or a format specified by a DVD-recording standard (DVD-VR format).

Here, the device in FIG. 1 supplies formatted information (a pack of video, audio, sub-video data, and so on) and prepared management information in the formatter 51 to the hard disk drive unit 2001 or the optical disk drive unit 1002 via the data processor unit 1003, and can record the information in a hard disk or the optical disk 1001. In addition, the device can record information recorded in the hard disk to the optical disk 1001, or information recorded in the optical disk 1001 to the hard disk, via the data processor unit 1003 and the optical disk drive unit 1002.

In addition, the device can carry out edit processing, such as deleting a part of a video object of a plurality of programs recorded in the hard disk or the optical disk 1001, and coupling the video object with an object of a different program. This is because the DVD-VR format used in one embodiment of the present invention defines a data unit to be handled to facilitate editing.

The microcomputer block 30 includes a firmware ROM in which an MPU (micro processing unit) or a CPU (central processing unit), and a control program (firmware for carrying out control explained in each flowchart) are written, a work RAM for providing a work area necessary for executing a program. The MPU of the microcomputer block 30 uses the RAM as a work area in accordance with a control program stored in the ROM of the microcomputer block 30 to execute a defect location detection, unrecorded region detection, recording information and recording position setting, UDF recording, AV address setting, history information detecting processing, and so on.

That is, the microcomputer block 30 has an information processing unit necessary for integration control of an entire system, and includes the firmware ROM, the work RAM, and a directory detecting unit. In addition to these parts, the microcomputer block 30 also includes, although not shown, a VMG (entire video management information) information preparing unit, a copy-related information detecting unit, a copy and scrambling information processing unit (RDI processing unit), a packet header processing unit, a sequence header processing unit, an aspect contrast information processing unit, etc.

Here, in this device, an extent showing an access unit by using an address and information of the size of data in a data recording region of an information recording medium is defined. The device includes a plurality of the extents and uses a file entry that manages a file to record and reproduce data. For this reason, the microcomputer block 30 further includes a file entry management unit 301, which includes an extent management unit 302. Then, the extent management unit 302 has an deleting extent processing unit 310, a recorded extent management unit 311, and a recording extent management unit 312.

A content which should be reported to the user out of a result of the execution of the MPU described above is displayed on a display unit 43 of a video data recording and reproducing device, or displayed on a monitor display 75 in an OSD (on-screen display) manner. In addition, the microcomputer block 30 has a key input unit 44 that applies an operating signal for operating the device. The key input unit 44 corresponds to, for example, operating switches and the like provided on a main body of the video recording device, or a remote controlling device. In addition, the input unit 44 may be a personal computer connected to the video recording device according to an embodiment of the present invention by wire communication or wireless communication, or by using a means of optical communication and infrared-ray communication. In any form, when the user operates the key input unit 44, recording processing of an input video audio signal, reproducing processing of a recorded content, or edit processing of a recorded content can be applied.

The microcomputer block 30 can control the optical disk drive unit 1002, the hard disk drive unit 2001, the data processor unit 1003, the encoder unit 50 and/or the decoder unit 60 in a timing based on time data from an STC (system time clock) 38. Operation of recording and reproducing is normally executed in sync with a time clock from the STC 38. Processing other than recording and reproducing may be executed in a timing independent from the STC 38.

The decoder unit 60 has a separator that separates each pack from a signal of a DVD format having a pack structure and takes out the separated packs, a memory used at the time of pack separation and execution of other signal processing, a V decoder that decodes main video data (content of a video pack) separated by the separator, an SP decoder that decodes sub-video data (content of a sub-video pack) separated by the separator, and an A decoder that decodes audio data (content of an audio pack) separated by the separator. In addition, the decoder unit 60 includes a video processor that combines decoded main video with decoded sub video as appropriate, and outputs the main video after overlapping a menu, a highlighted button, a subtitle, and other items of sub video.

An output video signal of the decoder unit 60 is input to a video mixing unit 71. The video mixing unit 71 carries out combining of text data. In addition, the video mixing unit 71 is also connected with a line for directly receiving a signal from the TV tuner 42 and the A/V input unit 41. The video mixing unit 71 is connected with a frame memory 72 used as a buffer. When output of the video mixing unit 71 is analog output, the output is output externally via an I/F (interface) 73. When the output is digital output, the output is output externally via a digital analog converter 74.

An output audio signal of the decoder unit 60 is analog-converted in the digital analog converter 77 via an audio selector 76, and then output externally. The audio selector 76 is controlled by a select signal from the microcomputer block 30. In this manner, the audio selector 76 can also directly select a signal which passed through the encoder unit 50 when a digital signal form the TV tuner 42 and the A/V input unit 41 is directly monitored.

The formatter 51 in the encoder unit 50 creates each piece of segment information (information such as when a beginning of GOP (Group of Picture) interrupts) while recording, and regularly sends the segmented information to the MPU of the microcomputer 30. The segment information includes the number of packs of VOBUs (Video Object Units), an end address of I picture from the beginning of the VOBU, reproducing time of the VOBU, and so on. Simultaneously, the formatter 51 sends information from an aspect information processing unit to the MPU at start of recording, and the MPU creates VOB stream information (STI). Here, the STI stores resolution data, aspect data, and so on, and based on such information, initial setting is carried out in each decoder at reproducing.

In addition, in the device in FIG. 1, one disk includes one file as to a video file. In addition, the device sets a minimum continuous information unit (size) so that reproduction can be carried out seamlessly while the device accesses (seeks) data. This unit is called an extent (or a CDA). Size of the extent is, for example, a multiple of an ECC (error correcting code) block (16 sectors), and recording is carried out in a unit of the extent in a file system.

The data processor unit 1003 receives data in a VOBU unit from the formatter of the encoder unit 50, and supplies data in an extent unit to the optical disk drive unit 1002 or the hard disk drive unit 2001. In addition, the MPU of the microcomputer block 30 creates management information necessary for reproducing recorded data. When the MPU recognizes a command of terminating data recording, the MPU sends the created management data to the data processor unit 1003. In this manner, management information is recorded in a disk. Therefore, when encoding is carried out, the MPU of the microcomputer block 30 receives information in the data unit (segmented information) from the encoder unit 50. In addition, the MPU of the microcomputer block 30 recognizes management information (file system) read from the optical disk and the hard disk at the start of recording, recognizes an unrecorded area of each disk, and sets a data recording area on the disk via the data processor unit 1003.

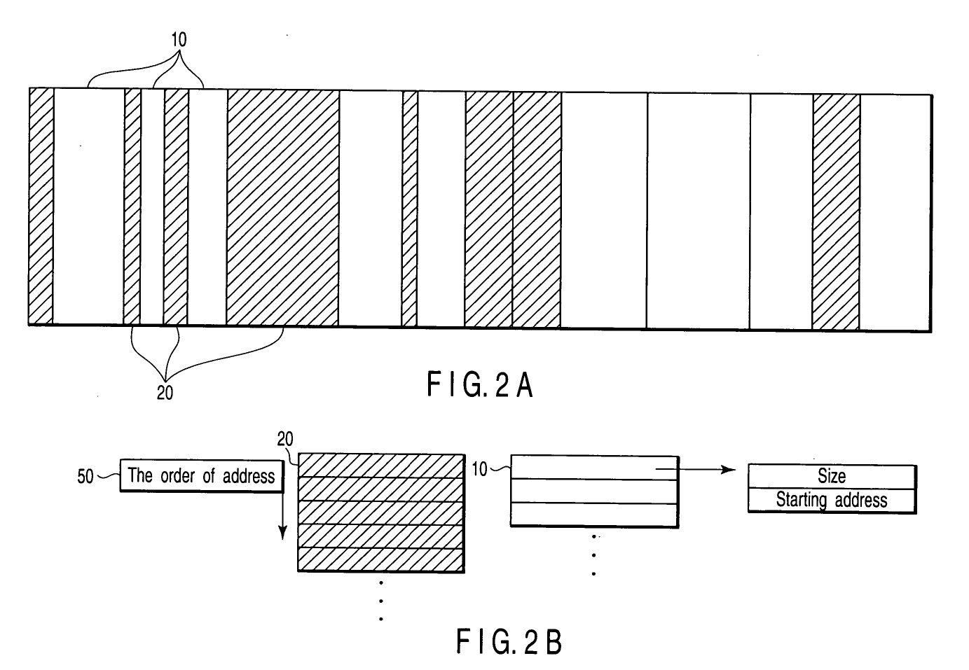

FIG. 2A shows a state of each extent in the HDD as a recording medium. The extent can be roughly classified into two types, a recordable extent (recordable region) 10 and a recorded extent (recorded region) 20, as shown in FIG. 2A. Information in each of the extents 10 and 20 is managed in a table format. An extent management table 50 shown in FIG. 2B manages information of the extents 10 and 20 arranged in the order of a starting address. Further, the recordable extent can be classified into two groups, the extent used for recording and the extent retained without being used for recording according to size.

Hereinafter, a data recording method in a case where recording data in the HDD is carried out by one encoder (recording device) at a time. When the recording of data is started, the extent used as a recording extent first is the recordable extent appearing first in the extent management table 50. The encoder carries out the recording of data to this extent. When the recording of data is carried out, recording capacity may be insufficient only with the extent allocated first. In this case, the recordable extent needs to be newly allocated. For this reason, the encoder refers to the extent management table 50 again, and allocates the recordable extent subsequent to the extent currently being recorded to carry out the recording continuously.

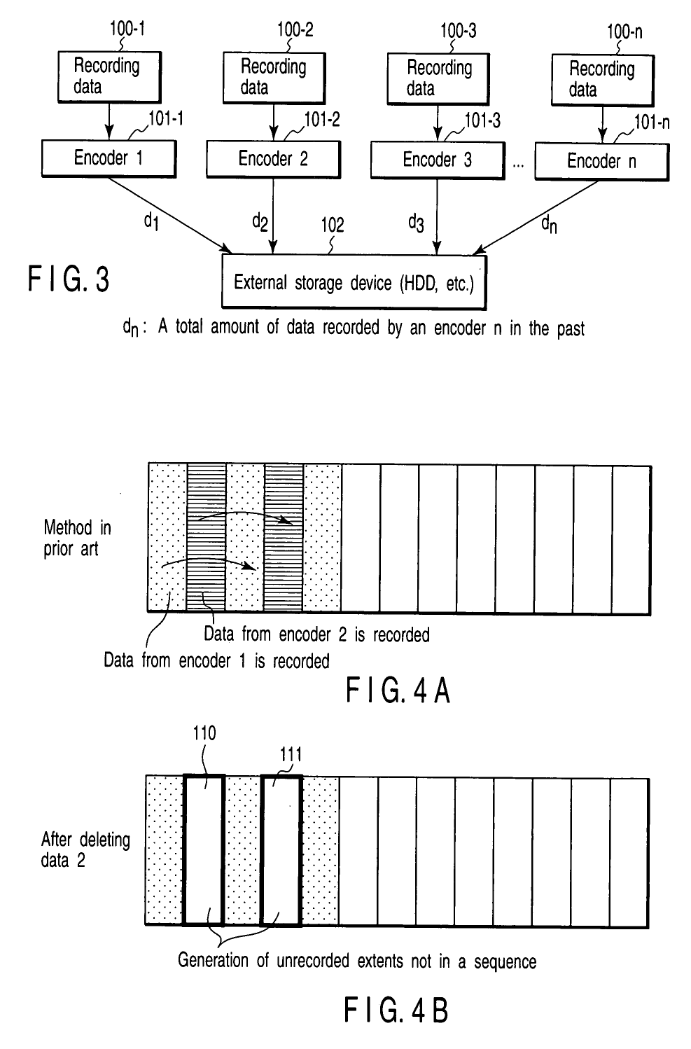

Next, a case in which two types or more of data is simultaneously recorded in the HDD. FIG. 3 shows a configuration where a plurality of pieces of data are simultaneously recorded. A plurality of pieces of recording data 100-1 to 100-n are input to a plurality of encoders 101-1 to 101-n respectively, and such data is simultaneously recorded in an external storage device (HDD in this case) 102.

When the plurality of pieces of recording data 100-1 to 100-n are simultaneously recorded in the HDD 102, the extent to which each piece of data is recorded first needs to be determined. At this stage, when the recordable extent at the beginning is allocated to the first piece of data and the subsequent recordable extent in the order of address is allocated to the second piece of data, and as the recording proceeds and allocation of the extents are carried out one after another, these pieces of data turn out to be alternately recorded in the HDD 102 at the end.

FIG. 4A shows a state where recorded data from an encoder 1 and recorded data from an encoder 2 are recorded alternately in the HDD. As shown in FIG. 4A, when a plurality of pieces of data are alternately recorded, there are disadvantages such as a seek occurs at the time of reading, and also a recorded range of data becomes wider, and unrecorded extents 110 and 111 (FIG. 4B) having small capacity sandwiched by recorded extents from both sides may be easily created when a part of the data (for example, data recorded by the encoder 2) is deleted. That is, since one piece of data is divided and the divided pieces of data are recorded in locations distant from one another, a fragment may easily occur when editing and deleting of data are carried out.

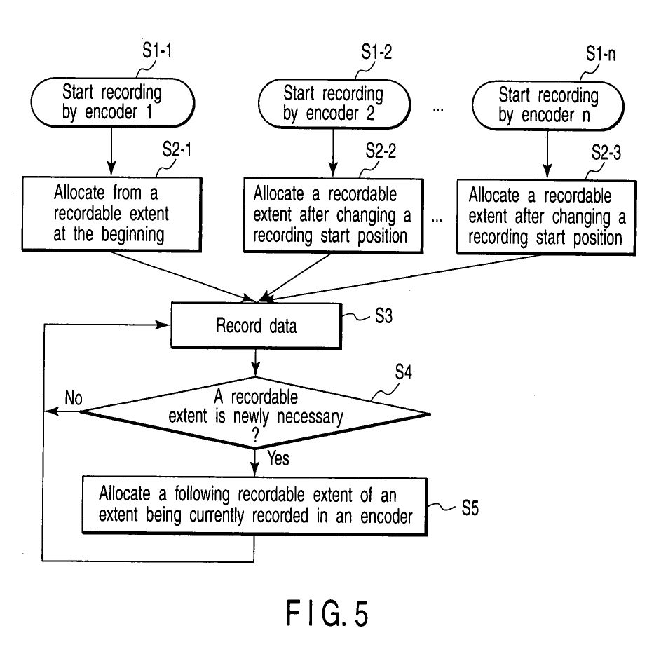

Hereinafter, an outline of a data recording method according to the present embodiment for achieving the above object will be described with reference to FIG. 5. Recording of recording data starts in each of the plurality of encoders 1 to n (blocks S1-1 to S1-n). Here, in the recording by the encoder 1-1, a recording start position is allocated from the recordable extent at the beginning (block S2-1). On the other hand, in the recording in the encoder 1-2 and the subsequent encoders, the corresponding recordable extent is allocated at a position which is apart from the recording start position of the encoder 1 for a predetermined distance as a recording start position (blocks S2-2, . . . , S2-n).

Next, recording of data is carried out from the recording start position allocated to each of the encoders 1 to n (block S3). When recording of data is carried out in this manner, recording capacity may be insufficient only with the extent allocated first. Therefore, whether the new recording extent is necessary or not is judged (block S4). If NO, the recording of data continues after the processing returns to block S3. If YES, the extent management table 50 is referred to, the recordable extent subsequent to the extent currently being recorded in the encoder is allocated (block S5), and then the processing returns to block S3 to continue the recording of data.

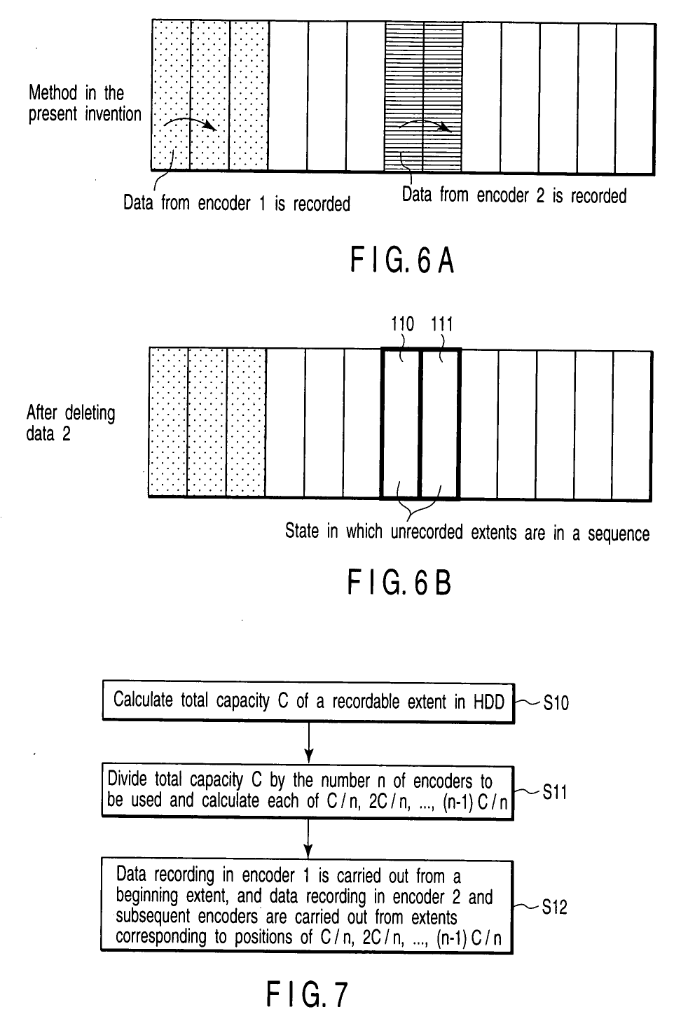

FIG. 6A shows a state where, in accordance with the method according to the present invention, the encoder 1 starts recording with the recordable extent at the beginning as a recording start position, and the encoder 2 carries out recording from the recordable extent corresponding to a position apart from the recording start position of the encoder 1 for a predetermined distance. FIG. 6B shows a state in which data recorded by the encoder 2 is deleted and the unrecorded extents 110 and 111 are created. In accordance with the method in the present embodiment, since the unrecorded extents 110 and 111 exist next to each other, a fragment is not created. As described above, according to the present invention, a data recording start position is changed when a plurality of pieces of data are recorded, so that restriction of creation of a fragment is made possible.

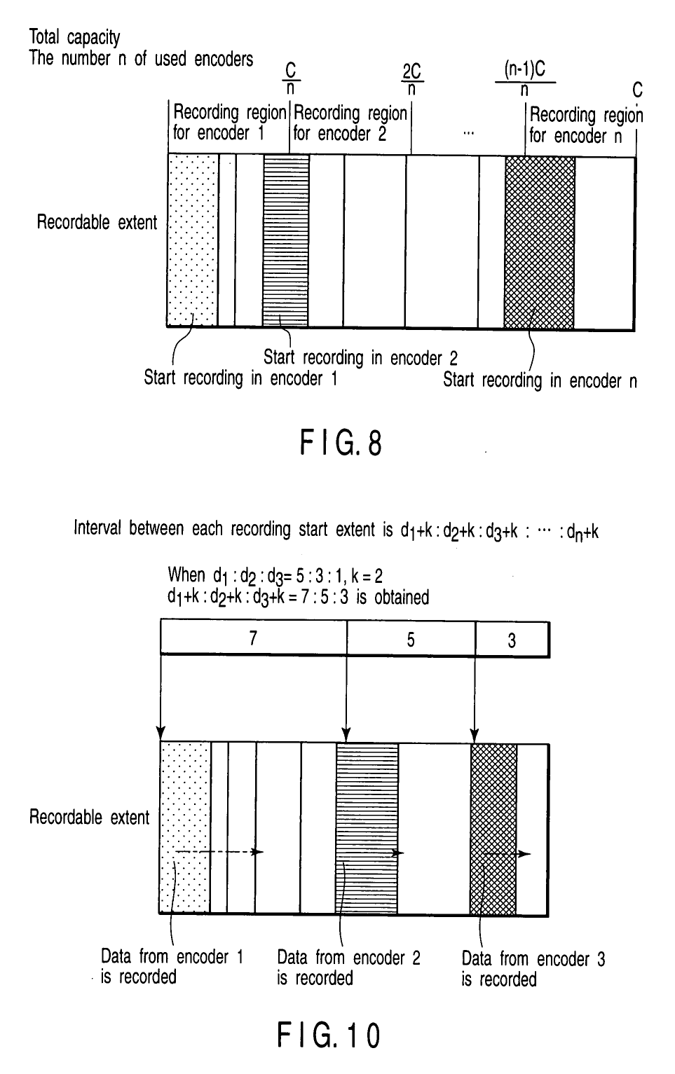

Hereinafter, a first embodiment of a data recording method will be described with reference to FIGS. 7 and 8. First, total capacity C of the recordable extent 10 in the HDD shown in FIG. 2A is calculated (block S10). Next, the calculated total capacity C is divided by the number of used encoders n to obtain C/n, 2C/n, . . . , (n−1)C/n (block S11). Next, the data recording in the decoder 1 is carried out from the recordable extent at the beginning. At the same time, as for the encoder 2 and the subsequent encoders, the recordable extents 10 corresponding to positions C/n, 2C/n, . . . , (n−1)C/n apart from the recordable extent in the beginning for a predetermined distance are allocated, and the data recording is carried out by each of the encoders 2 to n (block S12). FIG. 8 shows an example of such allocation of the extent at the time of recording a plurality of pieces of data.

In a case where recording is carried out in each of the encoders and the additional recordable extent becomes necessary, the recordable extent subsequent to the extent currently being recorded is used. As for a first piece of recording data, recording is first carried out in the recordable extent at the beginning, and if recording capacity becomes insufficient, recording is carried out in the second recordable extent. If the recordable extents are further necessary, the subsequent recordable extents are designated in the order of the third recordable extent, the fourth recordable extent, and so forth.

As for second and subsequent pieces of recording data, if the extent in which recording is first carried out assumes to be the n-th recordable extent, recording is subsequently carried out to the (n+1)-th extent, (n+2)-th extent, and so forth. Here, as a result of the subsequent recording, recording capacity may become insufficient only with the recordable extent first allocated to each piece of data. If there is no recordable extent for any piece of data, a recording location needs to be allocated by carrying out operation such as changing a region allocated for recording of other pieces of data.

As a method of reallocation, a method of dividing total capacity of all the recordable extents with the total number of the encoders again or a recording method of carrying out recording in the recordable extent at the beginning can be considered. However, in any case, complication of a state of data recording is not avoidable. Therefore, the recordable extents are desirably set such that the recording capacity is not in an insufficient state as much as possible. The methods described above can prevent changing of a recording start position in each of the encoders, and each piece of data recorded alternately in each of the extents on the HDD at the time of recording a plurality of pieces of data. Thereby, creation of a fragment can be restricted.

In setting a recording start position, such setting needs to be carried out in consideration of a recording location of each piece of data not becoming insufficient as much as possible. As a method of more efficient region setting, several examples will be shown below.

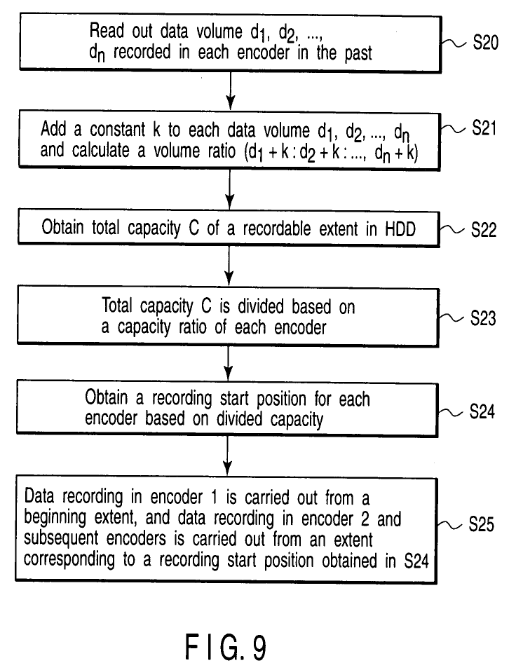

FIGS. 9 and 10 are views for explaining a second embodiment of the data recording method. The second embodiment is characterized by allocating many of the continuous recordable extents to the encoders with a high recording frequency in consideration of a high recording frequency in each of the encoders. As a precondition, each of data capacity d₁, d₂, . . . , dₙ recorded in each of the encoders in the past is stored in the HDD as data in advance. First, each of the data capacity d₁, d₂, . . . , dₙ recorded in each of the encoders in the past is read (block S20). Next, a constant k is added to each of the data capacity d₁, d₂, . . . , dₙ and a ratio of extent capacity (d₁+k:d₂+k:d₃+k: . . . :dₙ+k) is calculated (block S21). Here, an appropriate value is used for the constant k.

For example, as shown in FIG. 10, if d₁:d₂:d₃=5:3:1 and k=2, d₁+k:d₂+k:d₃+k=7:5:3 is obtained.

Next, the total capacity C of the recordable extents in the HDD is obtained (block S22). Next, the total capacity C is divided based on the content ratio with respect to each of the encoders (block S23). Next, the recording start position of each of the encoders is obtained based on the divided capacity (block S24). Next, the data recording in the encoder 1 is carried out from the recordable extent at the beginning, and the data recording in the encoder 2 and the subsequent encoders is carried out from the recordable extent corresponding to the recording start position obtained in block S24 (block S25). FIG. 10 shows an example of extent allocation in a case of recording three pieces of data simultaneously.

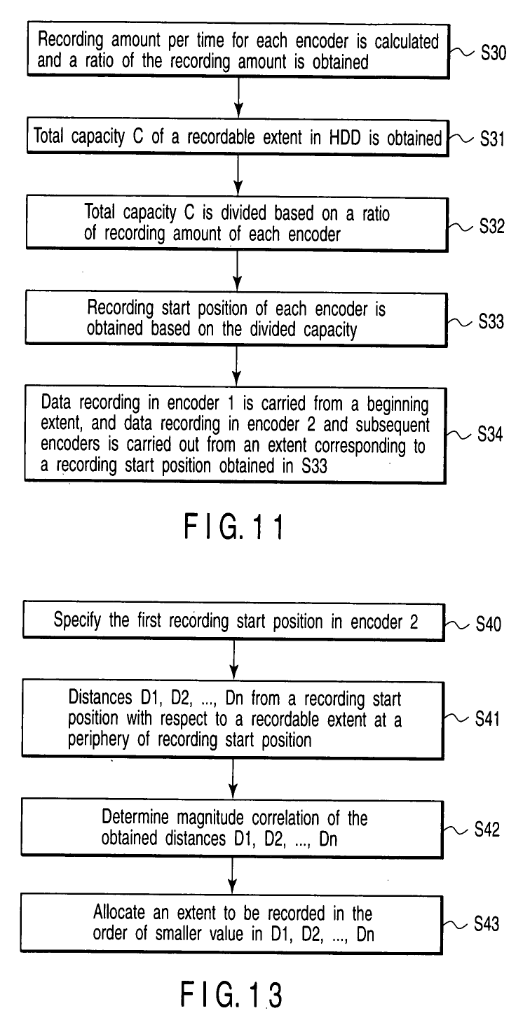

FIG. 11 is a view for explaining a third embodiment of the data recording method. The third embodiment is characterized by calculating a recording amount per unit time for each of the encoders, and the recording amount is set to be an allocation ratio of the recording extent. First, the recording amount per unit time for each of the encoders is calculated and a ratio of the recording amount is obtained (block S30). In a case of a recorder, etc., a bit rate of recording can be the judgmental standard. The encoder 1 records a moving image of 4 Mbps, and if the encoder 2 records a moving image of 8 Mbps, a ratio of the recording amount is 1:2. Next, the total capacity C of the recordable extents in the HDD is obtained (block S31). Next, the total capacity C is divided based on a capacity ratio for each of the encoders (block S32). Next, the recording start position of each of the encoders is obtained based on the divided capacity (block S33). Next, the data recording in the encoder 1 is carried out from the recordable extent at the beginning, and the data recording in the encoder 2 and the subsequent encoders is carried out from the recordable extent corresponding to the recording start position obtained in block S24 (block S34).

As a further modification example, if a plurality of HDDs are mounted, the configuration may be such that the HDD for recording can be allocated to each of the encoders separately, and the recording start position is changed. In this manner, a seek of a head occurring at the time the simultaneous recording is carried out to one HDD can be reduced.

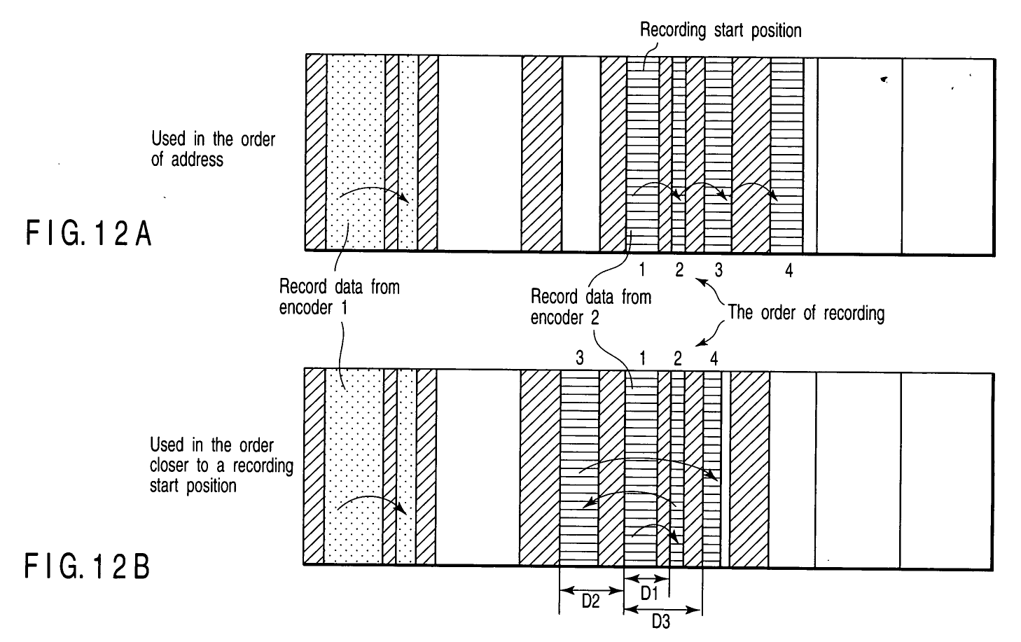

In addition, as for the method of allocating the new recordable extent at the recording, the next recordable extent subsequent to the extent currently being recorded has been allocated in the order of larger addresses with the recording start position as a base point (the order of 1, 2, 3, and 4 in FIG. 12A) with respect to the encoder 2 and the subsequent encoders as shown in FIG. 12A. However, apart from the method as described above, for example, the recordable extent can be allocated in the order of an extent having a closer address.

FIG. 13 is a view for explaining another method of allocating the recordable extent. Since the encoder 1 starts recording from the recordable extent at the beginning, the subsequent recordable extent is always used. On the other hand, the encoder 2 and the succeeding encoders, the order of recording is determined by a method shown in FIG. 13. First, the recording start position at the beginning by the encoder 2 is specified (block S40). Next, distances D1, D2, . . . , Dn is obtained from the recording start position for the recordable extent at a periphery of the recording start position (block S41). Next, a magnitude of the obtained distances D1, D2, . . . , Dn is determined (block S42). Next, based on the magnitude of the distances D1, D2, . . . , Dn, the recordable extent is allocated in the order of a shorter distance (block S43). FIG. 12B shows a state in which the recordable extent is allocated in the order in accordance with a distance from a periphery of the recording start position.

According to the method described above, the recording position converges at the closest position, therefore extents in which data is recorded are arranged in a gathered manner, and there is an advantage that seek time at recording and reproducing is shortened.

The embodiments described above prevent changing of a recording start position for each piece of recording data at recording a plurality of pieces of data, and recording of each pieces of data in the HDD alternately. In this manner, a problem such as fragmentation occurring in the method in the prior art described above can be resolved.

In addition, as a method of effectively carrying out the present technique, an allocation ratio at the time of allocating the recordable extent to each of the encoders is changed, thereby more recording regions can be set to the encoders with a large amount of recording, and also shortage of the recording region allocated to the encoders at recording can be prevented.

In addition, by changing an allocation method of the recordable extent, seek time of the HDD occurring at recording and reproducing can be reduced.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data recording method for recording a plurality of pieces of data simultaneously in a recordable region of a recording medium, comprising:
recording a plurality of pieces of recording data by each of a plurality of recording devices; and
allocating a recordable region so that each recording start position of the plurality of recording devices is different from one another when a plurality of pieces of recording data are recorded by the plurality of recording devices.

2. The data recording method according to claim 1, wherein the allocating comprises:
calculating total capacity C of the recordable region existing on the recording medium;
calculating C/n by dividing the calculated total capacity C by total number n of the plurality of recording devices, and also calculating 2C/n, 3C/n, . . . , {(n−1)C}/n which are integer multiple values of C/n; and
setting the recordable region at the beginning in the recording medium and the recordable region based on the calculated C/n, 2C/n, 3C/n, . . . , {(n−1)C}/n as a recording start position of each of the plurality of recording devices

3. The data recording method according to claim 1, wherein the allocating comprises:
calculating a ratio of recording frequency of each of the recording devices based on volume of data which has already been recorded by each of the plurality of recording devices;
calculating total capacity C of the recordable region existing in the recording medium;
dividing the calculated total capacity C based on the calculated ratio of the recording frequency; and
setting the recordable region at the beginning of the recording medium and the recordable region corresponding to each division of the divided capacity as a recording start position of each of the plurality of recording devices.

4. The data recording method according to claim 1, wherein the allocating comprises:
calculating a recording amount per unit time of recording carried out by each of the plurality of recording devices, and calculating a ratio of the calculated recording amount;
calculating total capacity C of the recordable region existing in the recording medium;
dividing the calculated total capacity C based on the ratio of the calculated recording amount; and
setting the recordable region at the beginning of the recording medium and the recordable region corresponding to each division of the divided capacity as a recording start position of each of the plurality of recording devices.

5. The data recording method according to claim 1, further comprising:
measuring a distance from the recording start position for the recordable region at a periphery of the recording start position; and
calculating a magnitude of the measured distance and determining an additional recordable region for carrying out recording in accordance with the magnitude.

6. A data recording device for recording a plurality of pieces of data simultaneously in a recordable region of a recording medium, comprising:
a recording unit which records a plurality of pieces of recording data by each of a plurality of recording devices; and
an allocation unit which allocates a recordable region so that each recording start position of the plurality of recording devices is different from one another when a plurality of pieces of recording data are recorded by the plurality of recording devices.

7. The data recording device according to claim 6, wherein the allocation unit comprises:
a first calculation unit which calculates total capacity C of the recordable region existing in the recording medium;
a second calculation unit which calculates C/n by dividing the total capacity C calculated in the first calculation unit by total number n of the plurality of recording devices, and also calculates 2C/n, 3C/n, . . . , {(n−1)C}/n which are integer multiple values of C/n; and
a setting unit which sets the recordable region at the beginning on the recording medium and the recordable region based on C/n, 2C/n, 3C/n, . . . , {(n−1) C}/n calculated in the second calculation unit as a recording start position of each of the plurality of recording devices

8. The data recording device according to claim 6, wherein the allocation unit comprises:
a first calculation unit which calculates a ratio of recording frequency of each of the recording devices based on volume of data which has already been recorded by each of the plurality of recording devices;
a second calculation unit which calculates total capacity C of the recordable region existing in the recording medium;
a dividing unit which divides the total capacity C calculated in the second calculation unit based on the ratio of the recording frequency calculated in the first calculation unit; and
a setting unit which sets the recordable region at the beginning of the recording medium and the recordable region corresponding to each division of the capacity divided by the dividing unit as a recording start position of each of the plurality of recording devices.

9. The data recording device according to claim 6, wherein the allocation unit comprises:
a first calculation unit which calculates a recording amount per unit time of recording carried out by each of the plurality of recording devices, and also calculates a ratio of the calculated recording amount;
a second calculation unit which calculates total capacity C of the recordable region existing in the recording medium;
a dividing unit which divides the total capacity C calculated in the second calculation unit based on the ratio of the recording amount calculated in the first calculation unit; and
a setting unit which sets the recordable region at the beginning of the recording medium and the recordable region corresponding to each division of the capacity divided by the dividing unit as a recording start position of each of the plurality of recording devices.

10. The data recording device according to claim 6, further comprising:
a measuring unit which measures a distance from the recording start position for the recordable region at a periphery of the recording start position; and
a determining unit which calculates a magnitude of the measured distance and determines an additional recordable region for carrying out recording in accordance with the magnitude.
